(19) United States
(12) Patent Application Publication
(10) Pub. No.: US 2020/0221333 A1
(43) Pub. Date: Jul. 9, 2020

(54) Extracting Client Presence Cycles from Access Point Measurements

(71) Applicant: HEWLETT PACKARD ENTERPRISE DEVELOPMENT LP, Houston, TX (US)

(72) Inventors: Ataur Rehman, Hobli (IN); Manaswini Lakshmikanth Sugatoor, Hobli (IN)

(21) Appl. No.: 16/239,640

(22) Filed: Jan. 4, 2019

(51) Int. Cl. H04W 28/02; H04W 24/08; H04W 24/10; H04L 29/08

(52) U.S. Cl. CPC H04W 28/0284; H04L 67/24; H04W 24/10; H04W 24/08

(57) ABSTRACT

Access points in different areas of a site detect client devices present in their areas. To be detected, the clients need only be enabled for a wireless technology (for example, Wi-Fi); they need not activate location services or any specific application. A network management interface may control the access points to monitor the number of clients in different areas at different times and store the results to a database. Algorithms may operate on the stored data to discover predictable cycles of client presence such as working and nonworking days or peak and nonpeak hours.

### BACKGROUND

Client presence at wireless local area network (WLAN) sites may vary cyclically. Each day may have peak hours of high presence and nonpeak hours of low presence. In addition, each week may have days when presence is relatively high (e.g., working days) or low (e.g., non-working days). Each year may include seasonal presence cycles. Knowing the presence cycles typical of a site, network administrators may schedule updates, upgrades, and other work that may affect network performance for nonpeak hours when fewer users may be affected, or performance impacts may be less noticeable.

Client presence at some sites may be correlated with the presence of employees, customers, or other visitors to the site location. The correlation is strongest at sites people visit specifically, or at least primarily, to use the network. Examples of such sites include Internet cafés; business centers at hotels, convention venues, and transportation hubs; and workplaces where employees' duties are carried out using client devices. However, in localities where a large segment of the population habitually carries client devices, client presence may still be sufficiently correlated with visitor presence to serve as a useful proxy metric, even, at sites such as shops, restaurants and public buildings where only some of the visitors may actively use the network.

Some types of wireless access points sense the presence of client devices within their reception range. The WLAN's client discovery process identifies each client individually. This allows each client to be tracked separately as it enters, stays in, and leaves an access point's reception range. A network management platform can store and/or analyze the data from single or multiple access points.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, the order of processing may be altered for some functions, both internally and with respect to each other. That is, some functions may not require serial processing and therefore may be performed in an order different than shown or possibly in parallel with each other. For a detailed description of various examples, reference will now be made to the accompanying drawings, in which:

FIG. 1 illustrates a client presence monitoring system according to one or more disclosed examples.

FIG. 2 illustrates a method of determining client presence cycles according to one or more disclosed examples.

FIG. 3 illustrates instructions and data for determining client presence cycles stored on a non-transitory machine-readable storage medium according to one or more disclosed examples.

FIG. 4 illustrates a periodicity detection algorithm for extracting cycles from collected client presence data according to one or more disclosed examples.

FIG. 5 illustrates a baselining algorithm for removing outliers from client presence data according to one or more disclosed examples.

FIG. 6 illustrates skewness and kurtosis in client presence peaks according to one or more disclosed examples.

FIG. 7 illustrates extracted client presence cycles according to one or more disclosed examples.

### DETAILED DESCRIPTION

The description of the different advantageous embodiments has been presented for purposes of illustration and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the use contemplated.

Before the present disclosure is described in detail, it is to be understood that, unless otherwise indicated, this disclosure is not limited to specific procedures or articles, whether described or not. It is further to be understood that the terminology used herein is for the purpose of describing particular embodiments only and is not intended to limit the scope of the present disclosure.

Client presence cycles, per se, interest network administrators and other information technology (IT) professionals who need to plan sufficient capacity for peak times and find ways to save overhead costs during nonpeak times. Certain users in underprovided locations are also interested in client presence cycles; if the network is so busy at peak hours that their applications crash or slow down unacceptably, they may want to save their most demanding work for nonpeak hours.

Human visitor presence cycles, which may correlate in varying degrees with client device presence cycles, are of interest to a very broad range of parties. For example, business owners want to predict their busiest and least busy times so that staffing and other resource availability are allocated accordingly. Some customers may want to avoid crowds by visiting stores, theaters, and other venues at less popular times. Employers offering flexible work hours may want to stock break rooms for when most employees are on-site and reduce climate control in unused rooms when the fewest employees are there. Emergency responders may find it helpful to know whether the location of an incident is likely to be crowded or uncrowded.

Existing solutions in the, analytics of client presence and/or visitor presence may use any of a variety of data collection techniques. Some existing solutions, may track a business's sales volume over time to determine presence cycles. This may require access to a feed from the business's cash register or information from financial entities, such as credit card companies, facilitating the transactions. Such access may be complicated by automated security and privacy precautions. Besides, this approach does not account for visitors who are present but do not make purchases. Some existing solutions may track client devices that use a particular application to navigate the space or find special offers. This approach does not account for visitors who do not have the application, or who have it but do not open and use it for their present errand. Some existing solutions track clients that have location services, such as GPS, enabled. Some users, however, habitually turn their client devices' location services off except when specifically needed, either because of privacy perceptions or because location services historically consumed battery power quickly.

Once presence data is collected and stored for a desired length of time, presence cycles may be extracted. Some existing solutions may extract cycles directly from the raw time-dependent presence data. These data may be a superposition of many functions, both cyclic and non-cyclic. Daily, weekly, monthly, and seasonal cycles, as well as long-term growth or decline and anomalous one-time events, may all contribute to the time-dependent data so that each contribution may be distorted by all the others. Averaging, curve fitting, slope correction, and other smoothing techniques in the time domain may remove some distortions, but in some instances they may mask meaningful information.

In some disclosed examples, a wireless access point detects client presence and relays the information to a network management platform that collect, stores, and analyzes the data. The access points may detect any client that is powered on and enabled to use a wireless communication technology that is recognized by the access point. In the simplest case, the wireless communication technology is the one being provided by the access point (e.g., a WLAN compliant with IEEE 802.11 standards or any future successor). However, an access point that can sense clients using different wireless communication technologies may also be contemplated. In some disclosed examples, the client presence data are stored by the network management platform in a suitable data structure, such as a persistent database. The network management platform may also store one or more analytical algorithms to apply to the data in the data structure. The algorithms may include one or more of the following: a transformation to the frequency domain and autocorrelation to detect cyclic variations; baselining to exclude outliers and derive the most common behavior; or skewness and kurtosis analysis to detect asymmetry and spreading of the peaks, respectively.

Computer functionality may be improved by the disclosed approaches indirectly, by way of network functionality. If the most common cyclic behaviors of client presence are known, maintenance and power-saving operational modes can be reliably scheduled for nonpeak times, and high-performance operational modes can be used at peak hours. In addition, anomalous behavior can be identified early so that resources may be redistributed if necessary.

Providers of network services to customers or other parties may derive particular benefits from the disclosed solutions. Monitoring the client presence cycles at existing sites may enable a development team to schedule upgrades, updates, or other work on an existing deployment for a nonpeak time when fewer users may be affected. The same information may be used to categorize current customers' sites according to their business hours (e.g., morning hours, all day, evening hours or 24×7), which may be an important factor in the provider's own business analytics. Once the sites are categorized, the provider may compare deployment details and performance characteristics of sites in a given category at a given geographical location. For example, the Internet Control Message Protocol (ICMP) test, to determine the round-trip time (RTT) for sending a signal and receiving an acknowledgment may be performed on a group of sites and the results compared. If those sites are in the same category and time zone, they may all be in the same part of their client presence cycle at the time of the test. Knowing that all the sites had peak client presence (or nonpeak client presence) when tested removes the client presence variable from the comparison, thus removing a potential error source from the analysis.

Some branches of local government, such as transportation, sanitation, and law enforcement, may benefit from accessing information on client presence cycles collected in different parts of a city or county. Knowing which areas are likely to be crowded at what times may help officials allocate resources more efficiently.

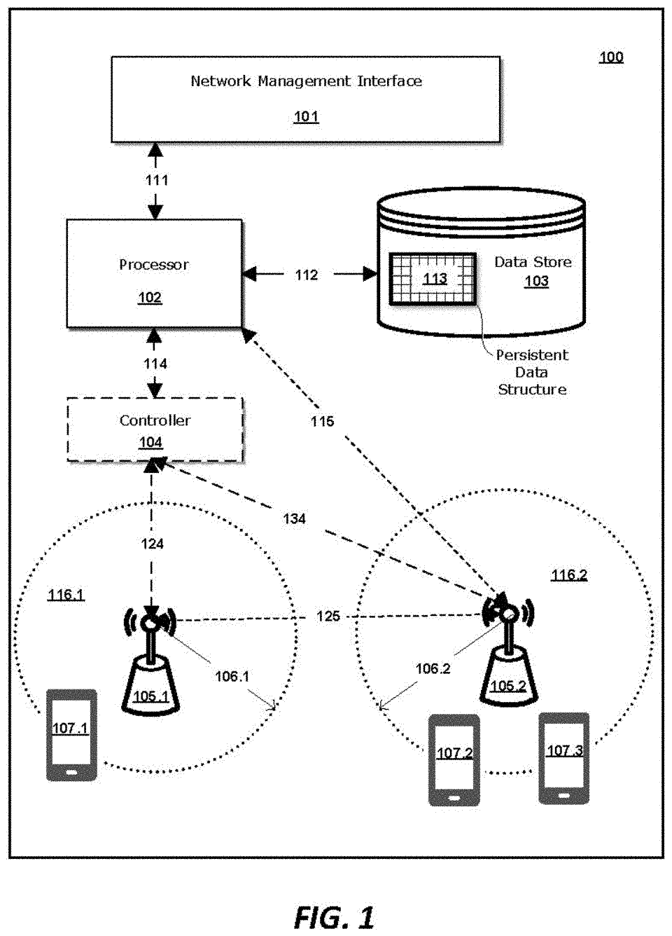

FIG. 1 illustrates a client presence monitoring system according to one or more disclosed examples. Access points 105.1 and 105.2 detect the presence of clients 107.1, 107.2. and 107.3 in areas 116.1 and 116.2, respectively. In some implementations, access points 105.1 and 105.2 detect any client using the wireless technology the access points provide, such as WiFi™. In other implementations, access points 105.1 and 105.2 may be configured to detect clients with other wireless technologies enabled as well. For simplicity, presence detection areas 116.1 and 116.2 are shown as circles of detection radii 106.1 and 106.2, respectively; however, areas 116.1 and 116.2 may have different shapes if walls or other obstacles are near access points 105.1 and 105.2. Presence detection areas 116.1 and 116.2 may or may not be coextensive with the WLAN coverage areas of access points 105.1 and 105.2. For example, if an access point has multiple transceivers implementing different wireless technologies (e.g., WiFi, BLE, ZigBee, etc.), the presence detection area may alternatively be an aggregate of the coverage areas of all the multiple transceivers.

In some implementations, access points 105.1 and 105.2 communicate with the rest of network 100 through controller 104 using links 124 and 134, with controller 104 communicating with processor 102 through link 114. However, in other implementations, one access point 105.2 may act as a virtual controller for other access points such as access point 105.1. In that case, controller 104 may not be present; processor 102 communicates directly with virtual controller access point 105.2 over link 115, and virtual controller access point 105.1 communicates with other access points such as access point 105.1 over links such as 125.

Processor 102 communicates with data store 103 over link 112 and with network management interface 101 over link 111. Through network management interface 101, an administrator may supply input or receive output from programs or logic in the processor, which in turn accesses data store 103, controller 104 if present, and access points 105.1 and 105.2. For example, persistent data structure 113 may be set up in data store 103. Incoming presence data (e.g., that access point 105.1 detects client 107.1 in area 116.1 and access point 105.2 detects clients 107.2 and 107.3 in area 116.2) may be collected periodically (controlled by a clock) or in response to a manual trigger and stored in persistent data structure 113 along with a timestamp. Once incoming presence data has been collected on multiple occasions over a threshold length of time, the stored presence data may be retrieved and analyzed: for example, to derive any cyclic behavior.

In some implementations, access points 105.1. and 105.2 can identify and track individual clients 107.1, 107.2, and 107.3. For example, if client 107.1 were to leave area 116.1 and enter area 116.2, access point 105.1 would stop detecting its presence and, at some later time, access point 105.2 would begin detecting its presence. If the incoming presence data were collected and stored, the stored data would show that client 107.1, in particular, entered area 116.1, spent some time there, exited area 116.1, then entered area 116.2. Similarly, if client 107.2 entered area 116.2 at 8 AM, client 107.3 entered area 116.2 at 8:05 AM and exited area 116.2 at 8:15 AM, then client 107.2 exited area 116.2 at 8:30 AM, the stored data would show, not only that clients entered at 8 and 8:05 and exited at 8:15 and 8:30, but that client 107.2 stayed in the area for 30 minutes, and client 107.3 stayed in the area for 10 minutes. In some implementations, the clients 107.x are identified by the access points without identifying their users. Since the users are not individually identified, user privacy is preserved.

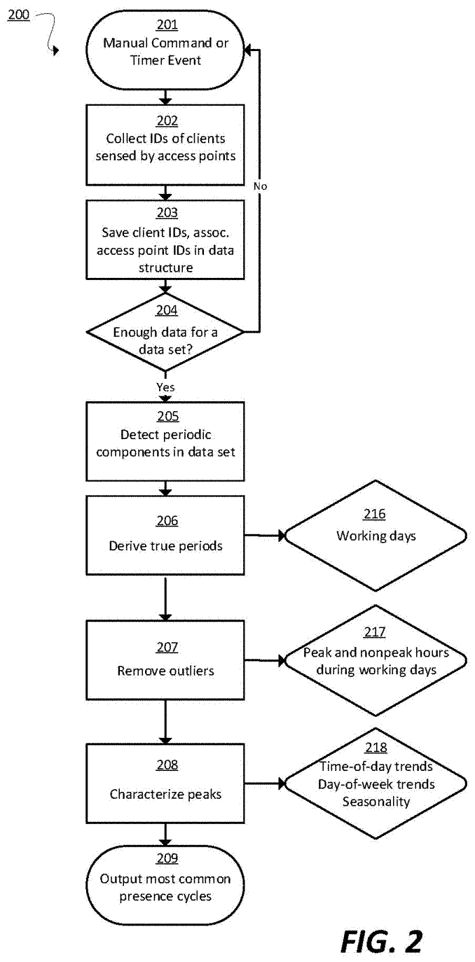

FIG. 2 illustrates a method of determining client presence cycles according to one or more disclosed examples.

Once enough data has been collected to provide the threshold sample size, the data may be input to periodicity detection algorithm 205. Because client presence data in the time domain may be a superposition of many cycles of different periods—daily, weekly, monthly, etc.—and offsets, a transform such as a fast Fourier transform may be used to convert the time-domain data to a periodogram, or frequency spectrum. Derivation of true periods 206 may include an autocorrelation of the periodogram. At this point, presence cycles with periods of 1 week or longer, such as working and non-working days 216, may be extracted.

Shorter presence cycles, such as peak and nonpeak hours in a day 217, may benefit from outlier removal 207 by a baselining algorithm that isolates the most common client behavior that will provide an accurate prediction most of the time. Suitable baselining algorithms include, but are not limited to, unsupervised machine learning via a one class support vector machine (SVM).

One advantage of an unsupervised approach is that outliers (anomalous data points) can be identified without a priori knowledge of their characteristics. In an SVM, data points are mapped into a space where points in a first class (e.g., points comporting with the most common behavior) are located on one side of a decision boundary and points in a second class (e.g., outliers) are located on the other side of the decision boundary. Some points, the support vectors, may be located on the decision boundary.

The desired decision boundary is a plane in three-dimensional space, which collapses to a line on a two-dimensional graph. In cases where the data force the decision boundary to be nonplanar, the SVM can project the space nonlinearly into a higher dimension where the decision boundary is planar. Some baselining algorithms benefit from optimization of hyperparameters such as v, the percentage of outliers expected in the data, and α, which controls how tightly the best-fit curve fits the individual data points. Choosing only the data points that fall on the “most common behavior” side of the decision boundary and looking at the presence cycles formed by those points may yield a more accurate prediction than averaging the raw data.

Trends and seasonality 218 in the presence cycles may be derived from characteristics 208 of the cycle peaks. For example, time of day trends are detectable as asymmetry in the peaks, characterized by a skewness factor:

$$Skewness factor = \frac{{\sum }_{i = 1}^{N} {( {Y}_{i} - \overline{Y} )}^{3} / N}{{s}^{3}} ,$$

where Yᵢ are individual data points, Y̅ is their mean value, N is the sample size and s is their standard deviation. One example of an asymmetric, presence peak might be detected by an access point monitoring a corporate break room during a break in a meeting. Clients might gradually filter into the area as some meeting attendees go there immediately, while others do other things first such as asking questions or checking their messages. In contrast, the clients might all leave the area much more abruptly when the meeting is about to resume. The resulting peak rises gradually, falls sharply, and the maximum number of clients is detected near the end of the break, rather than in the middle. The skewness factor would be positive because the peak is shifted to a time later than the middle of the break; a shift to an earlier time than the middle would produce a negative skewness factor.

Besides skewness, shifted peaks may exhibit kurtosis, meaning the peak is either narrower (heavy-tailed) or wider (light-tailed) than a best-fit normal distribution.

$$Kurtosis = \frac{{\sum }_{i = 1}^{N} {( {Y}_{i} - \overline{Y} )}^{4} / N}{{s}^{4}}$$

where Yᵢ are individual data points, Y̅ is, their mean value, N is the sample size and s is their standard deviation. In the break room example, a large subset of meeting attendees who enter and leave the area together while continuing a conversation may narrow the peak if they only stop briefly in the area, or they may widen it if they come in early and stay until the end. A normal distribution has kurtosis 3; higher values indicate a heavy-tailed distribution and lower values indicate a light-tailed distribution,

Once all these characteristics are evaluated, the most common presence-cycle behavior 209 can be determined.

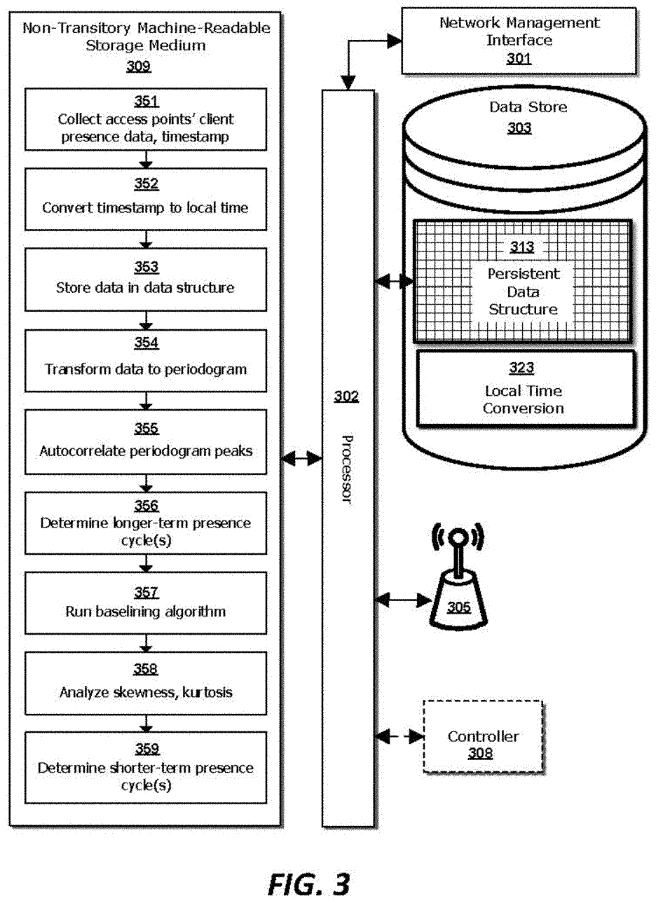

FIG. 3 illustrates instructions and data for determining client presence cycles stored on a non-transitory machine-readable storage medium according to one or more disclosed examples. Network management interface 301 enables an operator to control processor 302. For example, processor 302 may be caused to load and execute instructions from non-transitory machine-readable storage medium 309; to read data from data store 303; to write data to data store 303; and to control the operation of one or more access points 305 with or without controller 308, depending on the configuration. Data store 303 may include persistent data structure 313 of timestamped client presence data collected from access point(s) 305. Data store 303 may also include local time conversion data 323 to convert the timestamps in persistent data structure 313 to local time if needed; for example, if the timestamps as collected are in universal time.

The instructions stored in non-transitory machine-readable storage medium 309 may include 351, collecting client presence data from access point(s) 305 along with a timestamp in universal time; 352, converting the timestamp to local time; 353, storing the data in a data structure or set of data structures such as a persistence database; 354, transforming the raw time-domain data into a frequency-domain periodogram; 355, autocorrelating the periodogram to find the true period(s); 356, determining longer term, such as weekly, client presence cycles; 357, running a Baselining algorithm such as a one class SVM; 358, analyzing skewness and kurtosis of the peaks; and 359, determining shorter term presence cycles such as daily or hourly.

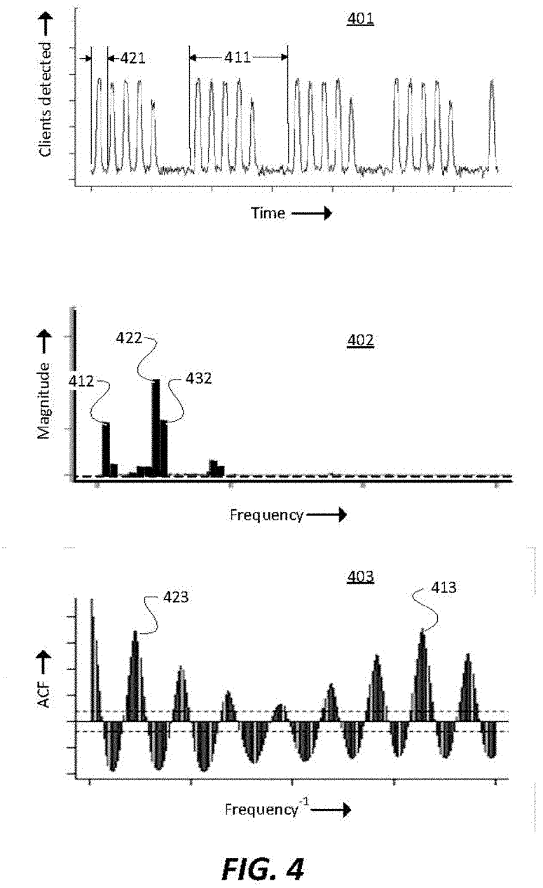

FIG. 4 illustrates a periodicity detection algorithm for extracting cycles from collected client presence data according to one or more disclosed examples. Time dependent data chart 401 shows raw data with multiple superposed cycles, primarily a short-term cycle 411 (e.g., a daily cycle) and a longer-term cycle 421 (e.g., a weekly cycle). Assuming that access point(s) would detect a significantly larger number of clients on a working day than on a non-working day, the site being monitored appears to have five working days and two non-working days per week. Periodogram 402 is the frequency-domain transformation of time dependent data chart 401. Low-frequency peak 412 corresponds to longer-term cycle 421 in time dependent data chart 401. High-frequency peaks 422 and 432 correspond to shorter-term cycle 411 in time-dependent data chart 401. To determine the true periods, periodogram 402 is autocorrelated, producing autocorrelation function plot 403. Peak 413 is the true longer period (e.g., 1 week) and peak 423 is the true shorter period (e.g., 1 day).

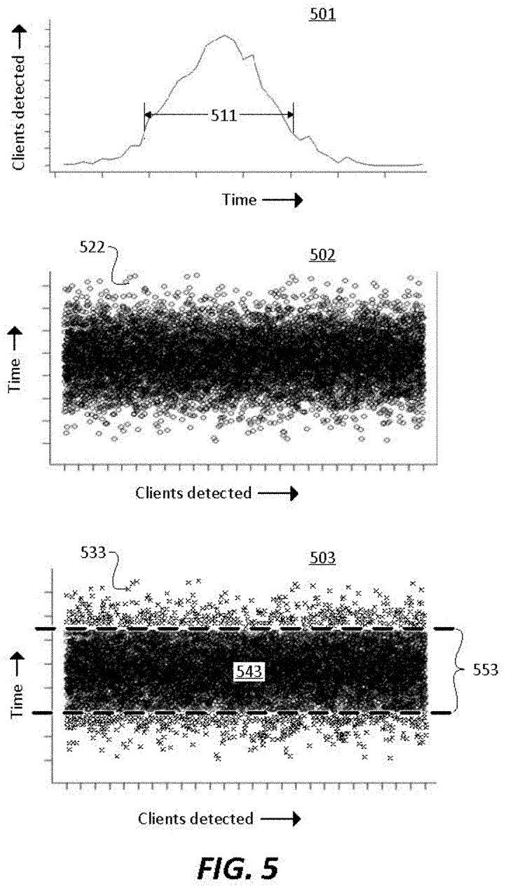

FIG. 5 illustrates a baselining algorithm for removing outliers from client presence data according to one or more disclosed examples.

The approximately bell-shaped curve of time-dependent data chart 501 represents variations in detected client presence over a period of one working day. Thresholding 511 attempts to define the peak hours, but the measurement is uncertain because the curve is rather noisy even after averaging multiple days. (Daily client presence at some sites, such as workplaces with somewhat flexible hours, may vary similarly to a normal distribution, but other types of sites may have presence curves with very different shapes. A convenience store near a high school, for example, may have a narrow peak at noon if students are allowed off-campus for lunch, and another narrow peak just after classes adjourn in the afternoon).

In raw-data graph 502, each point 522 represents a single measurement of client presence. One measurement was made, generating a corresponding data point, every 5 minutes for 30 days. The time of day the measurement was taken was plotted against the total number of clients counted. The graph shows a densely populated center band flanked by edge regions that are somewhat ragged and diffuse. To isolate the most common behavior and reduce the error in identifying the peak hours, the one class support vector machine baselining algorithm was applied to the data points of graph 502 to produce baselined graph 503. The algorithm identified the x-shaped points 533 as outliers and place them outside decision boundaries 553. Diamond-shaped points 543 inside decision boundaries 553 represent the most common behavior and will be separated out for further analysis. Decision boundaries 553 represent the beginning and end of the peak hours in a day.

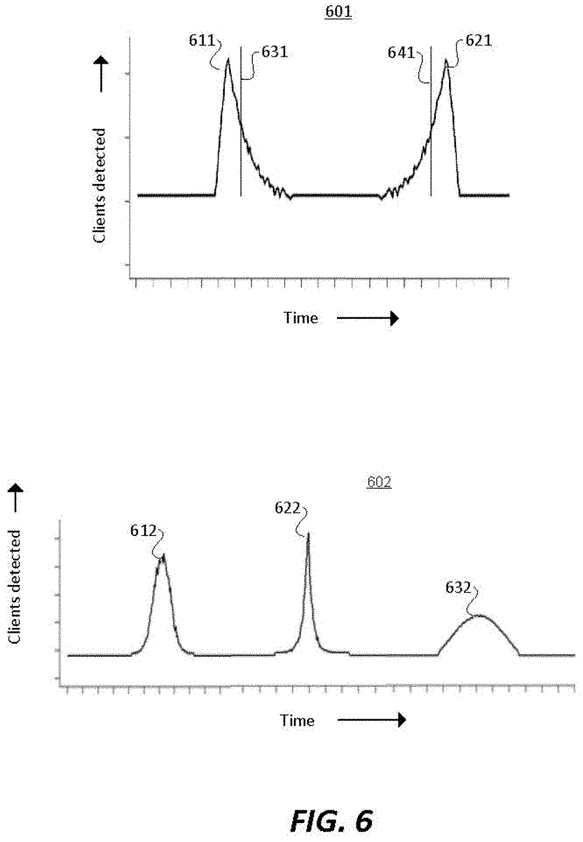

FIG. 6 illustrates skewness and kurtosis in client presence peaks according to one or more disclosed examples.

Skewness is a measure of the asymmetry of a statistical distribution. Because of the many contextual factors that influence visitors to enter and leave an area, the maximum client count does not always coincide with the center of the block of time identified as the peak hours. Sample graph 601 shows two asymmetric client presence curves. The peak on the left has negative skewness because its maximum 611 is shifted to the left of its spatial centroid 631. The peak on the right has positive skewness because its maximum 621 is shifted to the right of its spatial centroid 641.

Both asymmetric and symmetric statistical distributions may exhibit kurtosis. Sample graph 602 shows a peak 612 that has a normal distribution (kurtosis=3); a peak 622 with a “heavy-tailed” distribution that indicates a strong surge in client presence for a short duration (kurtosis>3); and a peak 632 with a “light tailed” distribution that indicates a steady stream of client presence for a longer duration.

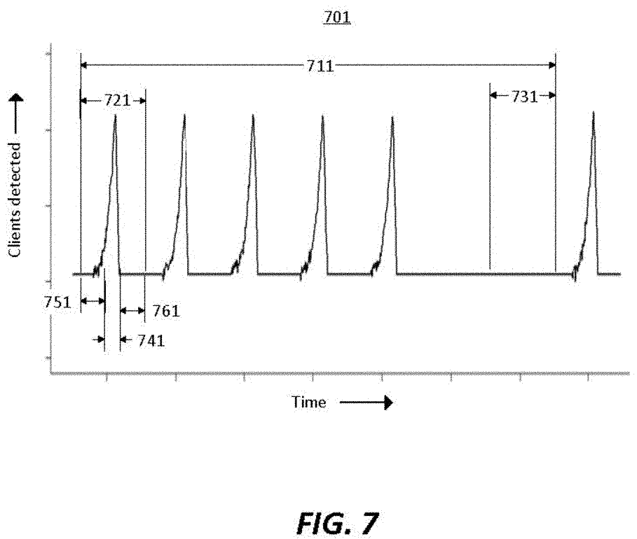

FIG. 7 illustrates extracted client presence cycles according to one or more disclosed examples. Graph 701 shows a work week 711 with working days 721 and nonworking days 731. Each working day 721 includes peak hours 741 and nonpeak hours 751, 761. The following information may be inferred from graph 701:

(a) Each week has 5 consecutive working days followed by 2 consecutive nonworking days. (The local time converter in the network management interface may display which days of the week are working or nonworking days at the site).

(b) The client presence on nonworking days and during nonpeak hours of working days is very low, virtually zero.

(c) The most clients are present near the end of each working day. At the beginning of the working day it increases gradually, but at the very end, it drops sharply. (The local time converter in the network management interface may display the local time corresponding to each measured number of clients).

Given that information, a network owner could further infer that the best times to repair and maintain the network would include the non-working hours and non-working days, especially shortly after the workday ended. However, if network capacity had to be reduced during a workday, it would cause less user impact if scheduled at the beginning of the day, as opposed to near the end.

Not all features of an actual implementation are described in every example of this specification. It will be appreciated that in the development of any such actual example, numerous decisions may be made to achieve the developer's specific goals for a particular implementation, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Certain terms have been used throughout the description and claim to refer to system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to.” Also, the term “couple” or “couples” is intended to mean either an indirect or direct wired or wireless connection. Thus, if a first device couples to a second device, that connection may be through a direct connection or an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A client presence monitoring system, comprising:
a first access point to sense a presence of all clients using a wireless communication technology in a first area;
a persistent data structure containing stored presence data from a plurality of clients at a plurality of times; and
a network management interface to collect incoming presence data sensed by the first access point and store part of the incoming presence data in the persistent data structure;
a processor to analyze the incoming presence data, the stored presence data, or both to extract periodic cycles of client presence over time.

2. The system of claim 1, wherein the first access point distinguishes between individual clients and the stored presence data comprises each client's arrival time, departure time, and length of stay in the first area.

3. The system of claim 1, further comprising a controller.

4. The system of claim 1, further comprising a second access point to operate as a virtual controller of the first access point.

5. The system of claim 4, wherein the second access point senses the presence of all clients using a wireless communication technology in a second area.

6. The system of claim 5, wherein the stored presence data sensed in the first area are distinguishable from the stored presence data sensed in the second area.

7. The system of claim 1, wherein the processor time-stamps the incoming presence data in universal time, the network management interface provides a conversion to local time, and the stored presence data in the persistent data structure is referenced to local time.

8. The system of claim 1, wherein the wireless communication technology comprises Wi-Fi.

9. A method of determining client presence cycles, comprising:
in response to a manual command or timer event, collecting identifiers of all clients sensed by an access point;
saving the identifiers with a timestamp in a data structure;
repeating the collecting and saving for a predetermined length of time to create a data set in the data structure;
detecting periodic components in the data set;
deriving true periods of the periodic components;
removing outliers from the data set to isolate most common behavior; and
characterizing the skewness and kurtosis of peaks in the most common behavior.

10. The method of claim 9, wherein the deriving of the true periods comprises an autocorrelation.

11. The method of claim 9, wherein the true periods comprise working days and non-working days.

12. The method of claim 9, wherein the removing of the outliers reveals the peak hours and nonpeak hours of a working day.

13. The method of claim 9, wherein the skewness and kurtosis reveal at least one of time-of-day trends, day-of-week trends, or seasonality.

14. A non-transitory machine-readable storage medium containing instructions that, when executed, cause a machine to perform actions comprising:
collecting time-stamped data on client presence in an area via an access point located in the area;
storing the time-stamped data in a persistent data structure;
detecting when the persistent data structure contains data representing a threshold length of time;
transforming the time-stamped data into a periodogram;
autocorrelating the periodogram;
inverse-transforming the periodogram back to the time domain;
baselining the data to remove outliers; and
analyzing skewness and kurtosis.

15. The non-transitory storage medium of claim 14, wherein the data structure is part of a database.

16. The non-transitory storage medium of claim 14, wherein the threshold length of time is at least 30 days.

17. The non-transitory storage medium of claim 14, wherein the threshold length of time is an integer multiple of a seasonal period.

18. The non-transitory storage medium of claim 14, wherein the autocorrelated periodogram yields client presence cycles of 1 week or longer.

19. The non-transitory storage medium of claim 14, wherein the baselining comprises a class support vector machine algorithm.

20. The non-transitory storage medium of claim 14, wherein the baselining comprises an algorithm that optimizes at least two hyperparameters.
